(19) United States
(12) Patent Application Publication
(10) Pub. No.: US 2024/0413428 A1
(43) Pub. Date: Dec. 12, 2024

(54) MOTOR VEHICLE AND BATTERY WITH A COOLING ELEMENT

(71) Applicant: AUDI AG, Ingolstadt (DE)

(72) Inventors: Wenkun HU, Bruchköbel (DE); Thomas RIEDMANN, Eitensheim (DE)

(73) Assignee: AUDI AG, Ingolstadt (DE)

(21) Appl. No.: 18/699,455

(22) PCT Filed: Sep. 30, 2022
(86) PCT No.: PCT/EP2022/077255

§ 371 Date: Apr. 8, 2024

(30) Foreign Application Priority Data
Oct. 8, 2021 (DE) 102021126133.3

(51) Int. Cl. H01M 10/6553; H01M 10/613; H01M 10/625; H01M 10/647; H01M 10/6556; H01M 50/103; H01M 50/55; H01M 50/593

(52) U.S. Cl. CPC H01M 10/6553; H01M 10/613; H01M 10/625; H01M 10/647; H01M 10/6556; H01M 50/103; H01M 50/55; H01M 50/593; H01M 2220/20

(57) ABSTRACT

A battery for a motor vehicle, which has a battery housing with a receiving region, a housing component which delimits the receiving region with respect to a first direction, and has at least one cell stack with at least one battery cell, which is arranged in the receiving region, so that a first side of the at least one battery cell faces the housing component and a second side of the at least one battery cell, which is different from the first side, has a first cell pole connection. Furthermore, the battery includes a passive cooling element associated with the at least one battery cell, which has a first connection region, which is coupled to the first cell pole connector of the at least one battery cell.

### FIELD

The invention relates to a battery for a motor vehicle, wherein the battery has a battery housing with a receiving region and a housing component that delimits the receiving region with respect to a first direction. Furthermore, the battery comprises at least one cell stack with at least one battery cell, wherein the at least one cell stack is arranged in the receiving region, so that a first side of the at least one battery cell faces the housing component and a second side of the at least one battery cell, which is different from the first side, has a first cell pole connection. Furthermore, the battery comprises at least one cooling element for cooling the at least one battery cell. Furthermore, the invention also relates to a motor vehicle having such a battery.

### BACKGROUND

Batteries for motor vehicles, especially high-voltage batteries that serve as traction batteries for motor vehicles, typically include numerous battery cells that are connected to a cooling structure. Especially in prismatic cells, such thermal connection usually occurs at the base of the cell. A housing component, in particular the housing base of the battery housing, is often designed as a cooling base. The cell terminals, which are also called cell pole connections in the context of the present invention, are usually located on a side of the battery cell opposite the cell base. These are often not thermally connected to a cooling device, as this is very complex due to the required tolerance compensation, for example when connected to a housing cover. This results in an uneven temperature distribution across the cell if it is only cooled at the base. In addition, in the event of thermal runaway of a battery cell, which is accompanied by enormous heating of such a battery cell, a lot of thermal energy can be transferred to the neighboring cell via the metallic cell connectors, which electrically conductively connect the cell pole connections of different battery cells of a cell stack or different cell stacks to one another, which in turn can promote thermal runaway of the neighboring cell. Although there are also known ways to connect battery cells to a cooling structure via their cell poles, such connections are usually extremely complex.

For example, EP 2 405 527 B1 describes a battery block with a plurality of individual battery cells, which are designed as flat cells and each have a positive and a negative connection lug. The connection lug of a first battery cell is electrically connected to a connection lug of a second battery cell, whereby this electrically conductive connection is provided by a spacer which is arranged between the two connection lugs. This spacer is made of an electrically insulating material and carries a contact plate for electrical contacting the connecting lugs. The electrically insulating part of the spacer is designed as a cooling device through which a fluid flows for cooling. For this purpose, the spacer has a hollow body. The design of such a cooling device is very complex in terms of installation space.

Furthermore, DE 10 2015 217 790 B4 describes an arrangement for cooling battery cells of a drive energy storage of a motor vehicle, wherein poles of at least two battery cells are interconnected via at least one cell connector and wherein a cooling device is arranged on a side of the cell connector opposite the battery cell in a thermally conductive connection and an electrically insulating connection to the at least one cell connector. The cooling device is designed in the form of a cooling plate with integrated cooling channels, which rests on the cell connector arrangement of multiple battery cells. This provides a sort of cover cooling for the respective cell poles. However, with such cover cooling there is the difficulty that manufacturing tolerances, especially in the direction of the height of the battery cells, i.e. in the direction of the cooling device, are very difficult to compensate for. This also results in a very complex cooling device.

The DE 10 2015 214 184 A1 describes a battery module with a cell assembly with a plurality of battery cells that are arranged adjacent to one another in an extension direction. At least one connection element in the form of a pole is arranged on the upper side of the battery cells. The connection elements of two adjacent battery cells are connected to one another via a cell connector. This has two connection portions for this purpose. The two connection portions are further connected to one another via a connecting portion of the cell connector, wherein this connecting portion extending in regions along a side surface of the battery cells which adjoin the upper side of the battery cells. Furthermore, the connecting portion can rest on a side wall of the battery module or can also be partially inserted into this side wall, wherein the side wall can be flowed through by a coolant and, for example, has a coolant inlet. The side wall is in turn fluidly coupled to a support device, which forms a base plate of the battery module.

### SUMMARY

It is therefore the object of the present invention to provide a battery and a motor vehicle which enable at least one cell pole connection of a battery cell to be cooled as efficiently as possible in the simplest possible manner.

A battery according to the invention for a motor vehicle has a battery housing with a receiving region and a housing component that delimits the receiving region with respect to a first direction. Furthermore, the battery comprises at least one cell stack with at least one battery cell, wherein the at least one cell stack is arranged in the receiving region, so that a first side of the at least one battery cell faces the housing component and a second side of the at least one battery cell, which is different from the first side, has a first cell pole connection. Furthermore, the battery comprises at least one cooling element for cooling the at least one battery cell. The at least one cooling element is designed as a passive cooling element, in particular associated with the at least one battery cell, which itself cannot be flowed through by a cooling medium, and which has a first connection region which is coupled in an electrically insulated manner to the first cell pole connection of the at least one battery cell, and has a second connection region, which is coupled to the housing component and/or a module housing different from the battery housing to provide a heat sink.

A passive cooling element is to be understood as meaning a cooling element which does not itself have a cooling medium flowing through it and therefore does not have to have any cooling channels through which such a cooling medium can flow. Rather, such a passive cooling element transfers the heat to a heat sink. This is provided in particular by the housing component, such as a housing base of the battery housing, which can, for example, be designed as a cooling base, as described at the beginning. This cooling element now advantageously makes it possible to connect the at least one cell pole connection, which is referred to here as the first cell pole connection, to the housing component, either directly to the housing component or indirectly via the module housing. This is preferably also thermally connected to this housing component, for example the housing base and/or housing cover, for example via a thermal adhesive or a thermally conductive compound or similar. If the cell pole connections are arranged laterally, the cooling element can also be designed in such a way that the thermal path leads to both a housing base and a housing cover as a heat sink. In this case, it is also particularly advantageous if, for example, the housing cover and/or the housing base are designed as active cooling devices and are designed to allow a coolant to flow through them.

By designing it as a passive cooling element associated with at least one battery cell, both space-efficient and space-saving as well as effective cooling can be provided for the battery cell. For example, if the battery comprises multiple battery cells, such a cooling element can be provided for a respective battery cell, in particular for each cell pole connection. This also simplifies tolerance compensation, since the cooling element then does not create a rigid connection between two battery cells. Tolerance compensation when connecting the cooling element to the module housing or the housing component that is not directly opposite the cell pole connection is also much easier to implement than, for example, by connecting to a directly opposite housing wall, since there is no exact adjustment to the distance between the cell pole connection and the directly opposite housing wall. Especially if the cooling element is connected to the module housing itself, such a cooling element can be designed independently of an absolute height or width of the battery cell, for example in the first direction. The first direction preferably corresponds to a vehicle vertical direction if the battery is arranged as intended in a motor vehicle. This means that the cooling element for each battery cell can be manufactured as an identical part, for example, which is significantly more cost-effective. Furthermore, the design as a passive cooling element can increase safety in connection with the battery, since the cooling fluid, which preferably flows through the housing base, can be safely kept away from the receiving region of the battery housing or does not flow through any element that is arranged only separated by insulation on the cell pole connections or cell connectors. If an active cooling element through which a cooling fluid flows were used to cool the cell pole connection, a leak in such a cooling device could be safety-critical, since the escaping, usually electrically conductive cooling fluid, such as water, could then come into direct contact with the cell poles and thus cause a short circuit. Overall, the invention can provide cooling for the battery, which enables cell poles to be connected to a cooling structure in a particularly simple, efficient and safe manner.

The module housing can represent a battery cell housing associated with the battery cell, with each battery cell included in the cell stack then having its own cell housing of this kind. However, the module housing preferably represents a housing associated with the cell stack, in which the at least one battery cell and in particular all battery cells included in the cell stack are arranged, i.e. in which the entire cell stack is arranged. The cell stack can therefore be part of a battery module, which has the module housing as its own module housing. In other words, the cell stack can be arranged in the module housing and the module housing can in turn be arranged in the battery housing. The connection of the at least one battery cell to the housing base can then also take place via a thermal connection of the cell base to the module housing base, which in turn is arranged on the housing base, for example via a thermally conductive compound, a thermally conductive adhesive or a thermally conductive pad or similar. However, the module housing does not necessarily have to have a module base, but can also be designed, for example, as a clamping frame, clamping band or similar. The battery for the motor vehicle is preferably designed as a high-voltage battery. This can include not just a cell stack with just one battery cell, but basically numerous battery cells. These can be grouped into several cell stacks. In other words, the battery can comprise multiple cell stacks, each with multiple battery cells. The invention is preferably used for battery cells designed as prismatic battery cells. Nevertheless, the invention can also be used in the same way for round cells or pouch cells as the at least one battery cell. Moreover, the at least one battery cell can be formed, for example, as a lithium-ion cell. The cell stack can, for example, provide a battery module. To receive multiple cell stacks, the battery housing can also include multiple receiving regions. The individual cell stacks can, for example, also be arranged next to each other without spatial separation in the battery housing. Alternatively, the respective receiving regions can also be provided by individual compartments in the battery housing, so that the receiving regions are separated from one another, for example by side walls or partitions of the battery housing. These side and/or partition walls should then be understood as part of the battery housing and not of the module housing. Rather, a module housing in which the cell stack can be accommodated should be understood to mean a structure which, for example, has a clamping device that runs around the cell stack and rests directly on the cell walls of the cell stack. If the cooling element is also directly coupled to the housing base, the presence of such a module housing is not absolutely necessary. In this case, the cell stack can also be arranged directly in the battery housing or in a compartment provided by it.

In addition, the at least one battery cell also has a further second cell pole connection in addition to the first cell pole connection. One of the two cell pole connections is designed as a positive pole and the other as a negative pole. The two cell pole connections do not necessarily both have to be arranged on the second side of the battery cell, although this is still possible. For example, the first cell pole connection can be arranged on a side opposite the first side of the battery cell. The first side of the battery cell may, for example, be defined as an underside of the battery cell, in particular with respect to the first direction. In other words, the underside of the battery cell faces the housing base of the battery housing. The first cell pole connection can be arranged accordingly on an opposite upper side of the battery cell. In this case, it is also preferred that the second cell pole connection is also arranged on this upper side of the battery cell. Furthermore, the two cell pole connections can be arranged in an edge region of the upper side of the battery cell with respect to a second direction perpendicular to the first. This second direction is preferably also perpendicular to a third direction, which corresponds, for example, to a stacking direction in which several battery cells included in the cell stack are arranged next to one another. However, it is also conceivable that the cell pole connections are not arranged on the upper side of such a battery cell, but on a side different from the upper side and underside. For example, the second side of the battery cell can directly adjoin the underside of the battery cell in relation to the second direction defined above. In this case, it is also conceivable that the two cell pole connections are arranged on opposite sides, and correspondingly a second cell pole connection, for example, on a third side of the battery cell, which is opposite the second side of the battery cell. Preferably, the cell pole connections are not arranged on a side of the battery cell the surface normal of which runs at least mostly parallel to the third direction defined above, that is, which does not face a neighboring battery cell of the same cell stack.

In principle, the cooling element can be made of any material, for example metal, plastic or a composite material. It is particularly advantageous if the cooling element is made of a metallic material and is coupled to the first cell pole connection via an electrically insulating insulation element. A metallic material can also be understood as an alloy. Metallic materials have the great advantage that they generally have a very high thermal conductivity, which is much higher than that of typical plastics. This allows significantly more efficient heat dissipation to be provided via the cooling element to the heat sink. For example, the cooling element can be made of aluminum and/or steel. Aluminum is particularly light and has very good thermal conductivity. In order to ensure electrical insulation at least on the first cell pole connection, the connection of the cooling element to the cell pole connection can advantageously take place via an electrically insulating insulation element. This can also take on different forms and can be provided, for example, as a plastic plate, ceramic plate, thermal pad made of an elastomer or similar. The embodiment as an adhesive is particularly advantageous and therefore preferred. This advantageously also allows for fastening of the cooling element at the same time.

In a further advantageous embodiment of the invention, the battery has a cell connector that is electrically conductively connected to the first cell pole connection, wherein the insulation element is arranged between the cell connector and the first connection region of the cooling element. Such a cell connector can be provided, for example, as a type of busbar. The first cell pole connection can be electrically conductively connected to a further cell pole connection of a further battery cell via such a cell connector. Such a cell connector can, for example, be provided in the form of a thin rail which connects second cell pole terminals of two adjacently arranged battery cells to one another, wherein such a cell connector can also comprise tolerance compensation elements. Such a tolerance compensation element can be provided, for example, in the form of a selected portion of such a thin rail. The region of such a cell connector, which is arranged directly on the cell pole connection, is preferably flat on the side facing away from the cell pole connection. This makes it particularly easy to arrange the cooling element on this cell connector via the insulation element. The first connection region of the cooling element can be arranged directly above a cell pole connection in relation to a specific direction, wherein a respective cooling element is provided for each cell pole connection, for example. If the second side is opposite the first side of the battery cell, i.e. if the cell poles are arranged on the upper side of the battery cell, then the specific direction corresponds to the first direction, and if not, namely if the cell poles are arranged laterally, then the specific direction corresponds to the second direction. However, the first connection region can also be arranged with respect to the specific direction directly above an intermediate region between two cell pole connections of adjacent battery cells on the cell connector connecting these two cell pole connections being insulated by the insulation element. Here too, a cooling element can be provided for each intermediate region. However, the first connection region can also be arranged to cover one or more cell pole connections and/or one or more intermediate regions.

It is particularly advantageous if the first connection region of the cooling element is designed as a flat plate extending in the third direction, which covers all cell pole connections and intermediate regions of the respective second sides of the battery cells of at least one same cell stack in this third direction. The plate is thermally connected to the cell poles or the cell connectors arranged thereon via at least one insulation element, preferably via several insulation elements. It is particularly advantageous if, for example, at least one or exactly one such insulation element is provided per cell connector. A respective insulation element can be arranged directly above a respective cell pole connection with respect to the specific direction, wherein for example a respective insulation element can be provided for each cell pole connection. However, only one insulation element can be provided per cell connector. This can then be arranged at any position on the cell connector with respect to the third direction, for example, it can extend over the entire cell connector in the third direction or be arranged centrally, namely with respect to the specific direction directly above the intermediate region, or directly above one of the several poles electrically connected by the cell connector.

The coupling of the cooling element with the cell connector, for example via an adhesive layer providing the insulation element, is particularly advantageous, since not only can cooling of the relevant cell pole connection of the battery cell itself be provided, but, above all, cooling of the cell connector itself can be provided in the event of a thermal event can be prevented, whereby a thermal propagation of such a thermal event from one cell to the next can be prevented or at least delayed.

In a further advantageous embodiment, as already mentioned, the insulation element is designed as an adhesive layer made of an adhesive. An adhesive with good thermal conductivity is preferably used. In addition, the adhesive layer is preferably designed to be as thin as possible, in particular with a layer thickness in a direction that points from the cell pole connection to the cooling element of less than 1 mm, for example 0.6 mm. As a result, sufficient electrical insulation can be provided and the thermal resistance between the cell pole connection, in particular the cell connector, and the cooling element can also be minimized.

In a further advantageous embodiment of the invention, the cooling element has a curved and/or angled rail or is designed as such. In this case, the cooling element can, for example, be designed with only a single angle or with multiple angles or can include a single-angled or multiple-angled rail. This is particularly advantageous if the cell pole taps of the battery cell are arranged on an upper side of the battery cell as described above. If, for example, the first cell pole tap is not arranged on the upper side, the cooling element can, for example, simply be designed as a non-angled, flat rail. This can be guided with the end not arranged on the cell pole connection up to the housing base and/or housing cover as the housing component that acts as a heat sink, or it can only extend partially towards the housing base and be connected to the module housing.

In order to also enable good tolerance compensation, this rail can also be relatively thin, for example with a thickness of less than 1 cm, preferably less than 0.5 cm. For example, it can have a thickness in the range of a few millimeters. Since the rail or the cooling element is generally provided by a metallic material, very good heat dissipation can still be achieved.

In a further advantageous embodiment of the invention, the cooling element is arranged in the second connection region in direct contact with the module housing and/or on the housing component, in particular welded, screwed or glued on. If the cooling element is made of a metallic material and is connected to the module housing, electrical insulation can optionally also be provided between the cooling element and the module housing at the corresponding second connection point. This electrical insulation can in turn be provided in the form of an electrically insulating adhesive, which in turn is preferably designed to be a good thermal conductor. This can also be provided in the form of a very thin adhesive layer, which has a layer thickness of preferably less than 1 mm. The cooling element can also be screwed or welded to the module housing. The same also applies to the connection of the cooling element to the housing component, for example on the housing base and/or on the housing cover. Apart from an optional electrically insulating layer and/or a layer made of a thermally conductive compound, there is preferably no further element between the module housing or the housing component and the cooling element.

In a further advantageous embodiment of the invention, the battery has a connecting portion which runs in the first direction and has one end arranged on the housing component, which is arranged in a second direction next to the cell stack and which connects the cooling element to the housing component. This connecting portion can also be made of a metallic material. In particular, this connecting portion can even be made in one piece with the cooling element. In other words, the cooling element and the connecting portion can represent different portions of the same, integrally formed component. However, they can also be two separately provided components that are connected to one another. For example, the connecting portion can also represent a side wall or partition arranged on the housing component, which delimits the receiving region with respect to a second direction or a third direction. Such side walls or partition walls, which, for example, spatially separate the receiving regions for different cell stacks, which are designed as compartments, can also be connected to the cooling base, i.e. the housing base, or arranged directly on it. These are preferably also made of metallic material or working material and therefore also have very good thermal conductivity. The cooling element can therefore simply be connected to such a side wall, for example welded or screwed to it. This means that existing components can also be used to advantage.

However, the connecting portion can also be provided as a separate component and, for example, provided in addition to the side and/or partition walls described. Furthermore, this connection portion can be a connection portion associated with the battery cell in question. In other words, at least one such connection portion can be associated with a respective battery cell. However, there is also the possibility that such a connection portion is shared by several battery cells, for example all battery cells of the same cell module, in order to connect the respective cooling elements associated with the individual battery cells. In the first case, the connecting portion can be designed as a rail or web or plate, similar to the cooling element, in the latter case, for example, as a plate extending in a third direction or the like.

In a further advantageous embodiment of the invention, the cell stack has a plurality of battery cells arranged next to one another in a third direction, comprising the at least one battery cell, wherein the battery has at least one cooling element, preferably two cooling elements, for each of the battery cells, via which the at least one first cell pole connection of the respective battery cell is coupled to the module housing and/or the housing base. Preferably, both cell pole connections of a respective battery cell are coupled to the module housing of this respective battery cell and/or the housing component via such a cooling element. The coupling with the housing component can also be achieved, for example, via a common connection portion as described above. However, a separate connecting portion can also be provided for each cooling element. The decoupling of the cooling elements from one another, at least in some regions, for example at least in the region of their first connection regions, enables a significantly more flexible tolerance compensation and a more flexible decoupling of the cells from one another. The width of a cooling element in the third direction is therefore preferably at most as large as a width of the battery cell associated with the cooling element in the third direction. This allows efficient cooling of multiple cells of a cell stack to be provided at the same time. The same applies to multiple cell stacks, which in turn can each contain multiple battery cells. This means that a cell pole cooling can be provided for each cell stack of the battery, as described using the example of the present cell stack. In this case, all battery cells and all cooling elements can be designed as described for the at least one battery cell and the at least one cooling element, and in particular, all battery cells and all cooling elements can be designed in the same way.

Furthermore, it is very advantageous if the housing component is designed as a cooling wall or as a cooling cover or as a cooling base and has at least one cooling channel through which a coolant can flow. The battery cells can also be arranged with their first sides on the housing component. This makes it possible, for example, to simultaneously provide cooling for the battery cells via their first sides. In other words, as already described, the battery cells can be thermally connected with their respective first sides to this cooling wall, for example a cooling base. This makes it possible to cool each battery cell on the underside as well as on the upper side via its cell pole connections. This advantageously results in particularly uniform and homogeneous cooling across the entire battery cell. If the cell pole connections are arranged laterally, it is preferred that both the housing base is designed as a cooling base and the housing cover is designed as a cooling cover, the cell poles are each connected via the cooling element to both the cooling base and the cooling cover and optionally additionally the cells with their first sides to the cooling base and the sides opposite their first sides are additionally connected to the cooling cover, for example. Hot-spots within the cell can be avoided efficiently.

Furthermore, the invention also relates to a motor vehicle having a battery according to the invention or one of its embodiments. The advantages mentioned for the battery according to the invention and its embodiments thus apply likewise to the motor vehicle according to the invention.

The motor vehicle according to the invention is preferably designed as an automobile, in particular as a passenger car or truck, or as a passenger bus or motorcycle.

The invention also comprises the combinations of the features of the described embodiments. The invention therefore also comprises implementations that respectively have a combination of the features of multiple of the described embodiments, provided that the embodiments have not been described as mutually exclusive.

### BRIEF DESCRIPTION OF THE FIGURES

Exemplary embodiments of the invention are described hereinafter. In particular:

FIG. 1 shows a schematic representation of a battery with a cell stack, of which only one battery cell is shown as an example, and a thermal connection of a cell pole connection via a cooling element to a module housing according to an exemplary embodiment of the invention;

FIG. 2 shows a schematic representation of a battery with a cell stack, of which only one battery cell is shown as an example, and a thermal connection of the cell pole connection of the battery cell via a cooling element to a housing base according to a further exemplary embodiment of the invention; and

FIG. 3 shows a schematic representation of a battery with a cell stack, of which only one battery cell with lateral cell pole connections is shown as an example, and a thermal connection of a cell pole connection of the battery cell via a cooling element directly and indirectly to a housing base and a housing cover according to a further exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, the same reference numerals respectively designate elements that have the same function.

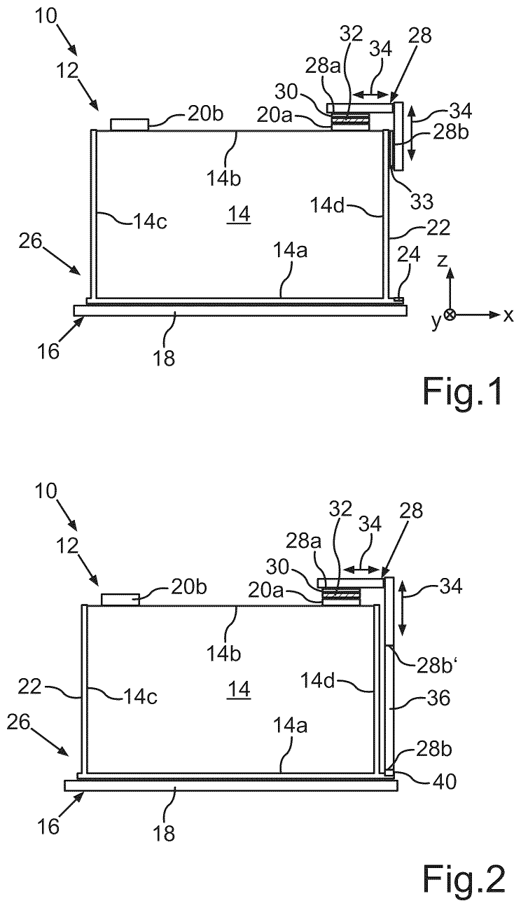

FIG. 1 shows a schematic representation of a battery 10 with a cell stack 12, of which only one battery cell 14 is shown as an example, according to an exemplary embodiment of the invention. The cell stack 12 can generally include several such battery cells 14, which can be arranged next to one another in a stacking direction, this stacking direction corresponding to the y-direction shown here. In other words, several such battery cells 14 can be arranged next to one another in the y direction. Furthermore, the battery 10 includes a battery housing 16, of which only a housing base 18 is shown here. This is preferably designed as a cooling base and comprises, for example, one or more cooling channels through which a cooling medium, for example water, can flow. In the present case, the battery cell 14 is designed as a prismatic battery cell and has a first side 14a, which in this example represents an underside 14a of the battery cell 14, and a second side 14b, which in this example represents an upper side opposite the underside 14a. In addition, the battery cell 14 has a third side 14c and a fourth side 14d delimiting the cell 14 in the x-direction. Furthermore, the battery cell has two cell pole connections 20a, 20b. One of the two cell pole connections 20, 20b is designed as a positive pole, the other as a negative pole. In this example, the cell pole connections 20a, 20b are arranged on the upper side 14b of the battery cell 14. Alternatively, these can also be arranged on the third side 14c and/or fourth side 14d. It is also conceivable that the two cell pole connections 20a, 20b are arranged on different sides of the battery cell 14, for example one on the third side 14c and the other on the fourth side 14d. In any case, the cell pole connections 20a, 20b are arranged on a side different from the underside 14a of the battery cell 14.

The battery 10 also includes a module housing 22 in which the cell stack 12 is arranged. This module housing 22 can be made of metal, for example aluminum. The battery cell 14 is thermally connected to the housing base 18 designed as a cooling base 18 via this module housing 22, in particular its underside. For this purpose, a thermally conductive adhesive or a thermally conductive compound 24 can be arranged between the underside 14a of the battery cell 14 or the module housing base and the cooling base 18. This also applies to all remaining cells 14 of the cell stack 12. Furthermore, the battery cell 14 or, in general, the cell stack 12 is arranged in a receiving region 26 of the battery housing 16. This receiving region 26 is limited accordingly with respect to the z direction downwards by the housing base 18. Laterally, that is, for example in the x and/or y direction, the receiving region 26 for a respective battery module or a respective cell stack 12 can also be delimited by side walls and/or partitions (not shown here).

In conventional batteries, the cooling of such battery cells is normally limited to cooling from below, for example through the cooling base described. Accordingly, there is no thermal connection of the cell terminals to a cooling structure. This results in an uneven temperature distribution across the cell, especially in the z direction. In addition, in the event of a thermal runaway, a lot of thermal energy can be transferred to the neighboring cell via cell connectors that electrically contact adjacent cells with one another, since such a cell connector is usually not coupled to a heat sink, or only indirectly via the cell itself, which in turn can facilitate a thermal runaway of he neighboring cell. The heat input to a terminal and thus the uneven temperature distribution across the cell limits the charging and discharging currents. In addition, without a thermal connection of the terminals, the heat energy that can be transferred via the cell connectors can infect the neighboring cell or at least promote this in the event of a thermal runaway.

The invention now advantageously enables a thermal connection of the cell terminals, i.e. the cell pole connections 20a, 20b, to the module housing 22 or the battery housing 16, which in turn is thermally connected to the heat sink, which is provided in particular by the cooling base 18.

This thermal connection takes place via a cooling element 28. FIG. 1 shows an example according to which one of the cell pole connections 20a is connected to the module housing 22 via this cooling element 28. The module housing 22 is in turn thermally coupled to the cooling base 18. The cooling element 28, which is preferably formed from a metallic material, has a first connection region 28a, which is coupled to a first cell pole connection 20a, and a second connection region 28b, which is coupled to the module housing 22. The coupling of the first connection region 28a is not carried out in particular by a direct connection of the cooling element 28 to the cell pole connection 20a, but instead via an electrically insulating connection, which is provided in the form of an insulating element 30, to a cell connector 32. This cell connector 32 can be designed as described above and electrically connect the cell pole connection 20a to the cell pole connection of a neighboring cell within the same cell stack 12. The cell connector 32 can be designed, for example, as a type of thin busbar. In the coupling region for coupling with the cooling element 28, the cell connector 32 is preferably designed to be flat on the side facing the cooling element 28. This facilitates the connection to the cooling element 28. The insulation element 30 is also preferably designed as a thin adhesive layer. This can have a layer thickness in the z direction of, for example, less than 1 mm, for example 0.6 mm. Furthermore, in this example, the cooling element 28 is designed as an angled rail. If, for example, the first cell pole connection 20a is not arranged on the upper side 14b of the cell 14 as shown in FIG. 1, but instead, for example, on the fourth side 14d, then the cooling element 28 can instead also be designed as a straight rail, that is, without an angle, especially a 90 degree angle, like in this example. The connection of the cooling element 28, in particular in the second connection region 28b, to the module housing 22 can also take place via an adhesive layer 33, which in turn can optionally be designed to be electrically insulating, or also through a direct connection between the cooling element 28 and the module housing 22, for example by welding and/or screwing or similar. In addition, a separate cooling element 28 of this type can be provided for each cell 14 of the cell stack 12. In particular, two such cooling elements 28 can be provided per cell 14, one for each cell pole connection 20a, 20b. In other words, the second cell pole connection 20b can also be connected to the module housing 22 and/or the cooling base 18 via such a cooling element 28, as described in the case of the first cell pole connection 20a.

By designing the rail as an angled rail 28 as shown in FIG. 1, tolerance compensation in both the x and z directions can be provided in a particularly simple manner. These tolerance compensations are illustrated by the arrows 34. For example, if the position of the cell pole connection 20a varies from cell to cell with respect to the x direction, this does not play a role in this embodiment of the cooling element 28. This would then simply protrude beyond the corresponding cell connector 32 more or less against the x direction shown. Even regardless of the height of the cell 14 in the z direction, such a passive cooling element 28 can always be optimally positioned and connected to the module housing 22. The connection point can then simply be shifted a little further up or down. In other words, the passive cooling element 28 can simply be designed as a common part for each cell 14 and does not have to take cell-specific tolerances into account during the design. Furthermore, the cooling element 28 is preferably solid, which in turn is beneficial to thermal conductivity.

The connection of the cell pole connections 20a via the cooling element 28 does not necessarily have to lead through the module housing 22, but can also be realized directly via the cooling base 18, as illustrated in FIG. 2.

FIG. 2 illustrates, using a further example of the invention, a battery 10 which can be designed in particular as described for FIG. 1, except for the differences described below. In this example, an additional connecting portion 36 is provided, which connects the cooling element 28 to the cooling base 18 and extends essentially parallel to the z-direction. The cooling element 28 is therefore not connected directly to the module housing 22. This connecting portion 36 can itself represent part of the cooling element 28. In other words, this connecting portion 36 and the remaining cooling element 28 can be formed in one piece, for example also in the form of an angled rail. The connecting portion 36 can also be provided as a separate component. In this case, the cooling element 28 can also only be limited to the horizontal portion 38. In other words, the entire portion shown vertically may represent the connection portion 36, or only a part thereof. This connecting portion 36 can also be provided, for example, by a partition or side wall of the battery housing 16, which separates several receiving regions 26 of respective cell stacks 12 from one another.

A common connection portion 36 can also be used for the respective cooling elements 28 of the respective battery cells 14, via which the respective cooling elements 28 are connected to the cooling base 18. This means there are numerous design options that allow for ideal adaptation to the situation. Here too, the connection of the second cell pole connection 20b can be carried out in the same way as shown for the first cell pole connection 20a. For example, if this connection element or the connection portion 36 is also included as part of the cooling element 28, the second connection region 28b is provided by the front side facing the housing base 18 of this connection portion 36, and, if not, by portion 28b′ of the cooling element 28, which is directly adjacent to this connection portion 36.

This embodiment also makes it possible to provide a particularly good thermal connection of the cell pole connections 20a, 20b to the housing base. Here too, a very simple tolerance compensation 34 can be provided in both the x and z directions. The tolerance compensation in the z direction can be provided or supported and simplified by introducing a heat-conducting element 40, for example in the form of a heat-conducting compound or an adhesive between the connecting portion 36 and the cooling base 18.

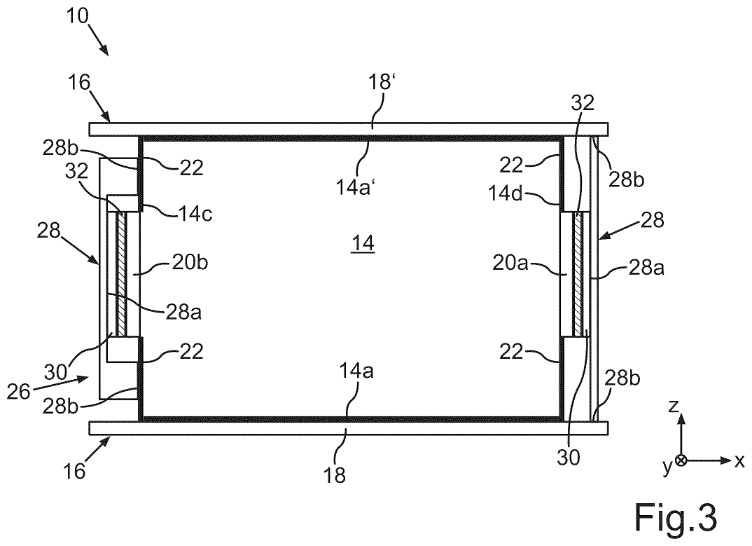

FIG. 3 shows a schematic representation of a battery 10 according to a further exemplary embodiment of the invention. The battery 10 can in turn be designed as before, except for the differences explained below. In this example too, the battery 10 comprises a cell stack 12, of which only one battery cell 14 is shown as an example. The cell stack 12 can again comprise multiple battery cells 14 arranged adjacent to one another in a stacking direction, wherein this stacking direction corresponds to the y-direction shown. Furthermore, the battery 10 comprises a battery housing 16, of which a housing cover 18′ is shown in addition to the housing base 18. In this example, the housing base 18 here is formed as a cooling base 18 and the cover 18′ is formed as a cooling cover 18′, and also comprises, for example, one or more cooling channels that can be passed through by a cooling medium, for example water. The battery cell 14 is in the present case designed as a prismatic battery cell and has a first side 14a, which in this example represents an underside 14a of the battery cell 14. The upper side of the battery cell is designated 14a′ in this example, since it also faces a housing component, namely the cover 18′, which is designed as active cooling and since in this example there are no cell poles 20a on this upper side 14a′, 20b are located. In this example, these are arranged laterally, namely on a third side 14c and a fourth side 14d, which lie opposite one another. Both cell poles 20a, 20b are connected to the base and cover cooling via a respective cooling element 28. For this purpose, a respective connection region 28a of the respective cooling element 28 is again arranged via an insulating element 30 on a cell connector 32, which is arranged in direct contact with the cell poles 20a, 20b.

FIG. 3 illustrates two different connection options that can be combined with each other as desired. The 20a cell pole connector shown on the right is connected directly to the cooling base 18 on the one hand and directly to the cooling cover 18′ on the other. The connection regions of the cooling element 28 are again designated 28b. The cooling element 28 thus has two second binding regions 28b, one is arranged on the cooling base 18 and one on the cover 18′, e.g. over a heat conduction element 40 (cf. FIG. 2) as described in FIG. 2. The cell pole connection 20b shown in FIG. 3 on the left is indirectly connected to the base cooling 18 and the cover 18′ via the cooling element 28, namely via a part of the module housing 22, in particular a side wall of the module housing 22. The module housing 22 may, for example, be formed in the form of a frame, in particular, so that there does not necessarily have to be a module housing wall on the underside 14a and the upper side 14a′ of cell 14. The module housing 22 is connected to both the cooling base 18 and the cooling cover 18′. The same connection variant can also be implemented via the cooling element 28 for both cell poles 20a, 20b, although not explicitly shown here. In both cases, the cooling element 28 can be provided, for example, in the form of a plate which in this example is aligned substantially parallel to the y-z plane. This cooling element 28 can extend over the entire cell stack 12 in the y direction. However, the insulation elements 30 can be segmented in the y direction. For example, an insulation element 30 can be provided per cell connector 32 and this can also be arranged at any position in the y-direction on this cell connector 32 and only partially or completely cover it in the y-direction. An insulation element 30 can also be provided for each cell pole connection 20a, 20b, which can then be arranged, for example, directly above the corresponding cell pole connection 20a, 20b with respect to the y-direction.

In this example, both the cooling base 18 and the cooling cover 18′ can also be connected directly to the underside 14a or upper side 14a′ of the respective cells 14. As a result, a respective cell 14 is cooled from four sides.

Overall, the examples show how a thermal connection of the cell terminals in a battery can be provided. This enables the cell to be cooled on both sides, which enables higher performance when charging and discharging. Furthermore, an even temperature distribution in the cell increases the cell lifespan. In addition, better temperature dissipation is provided in case of thermal runway of a battery cell and a corresponding contribution is made to preventing thermal runaway.

1-10. (canceled)

11. A battery for a motor vehicle, comprising:
a battery housing with a receiving region, a housing component which defines the receiving region with respect to a first direction,
at least one cell stack with at least one battery cell, wherein the at least one cell stack is arranged in the receiving region, so that a first side of the at least one battery cell faces the housing component and a second side of the at least one battery cell, which is different from the first side, has a first cell pole connection; and
at least one cooling element for cooling the at least one battery cell;
wherein the at least one cooling element is designed as a passive cooling element, which itself cannot be traversed by a cooling medium, and which has a first connection region that is coupled in an electrically insulated manner with the first cell pole connection of the at least one battery cell, and has a second connection region, which is coupled to the housing component and/or a module housing for providing a heat sink.

12. The battery according to claim 11, wherein the cooling element is formed from a metallic material and is coupled to the first cell pole connection via an electrically insulating insulation element.

13. The battery according to claim 12, wherein the battery has a cell connector electrically connected to the first cell pole connection, wherein the insulation element is arranged between the cell connector and the first connection region of the cooling element.

14. The battery according to claim 12, wherein the insulation element is designed as an adhesive layer made of an adhesive.

15. The battery according to claim 11, wherein the cooling element comprises a curved and/or angled rail or is designed as such.

16. The battery according to claim 11, wherein the cooling element in the second connection region is arranged in direct contact with the module housing and/or the housing component, in particular welded, screwed or glued thereto.

17. The battery according to claim 11, wherein the battery has a connecting portion which extends in the first direction, is arranged with one end on the housing component, is arranged in a second direction next to the cell stack and connects the cooling element to the housing component.

18. The battery according to claim 11, wherein the cell stack has a plurality of battery cells arranged next to one another in a third direction, comprising the at least one battery cell, wherein the battery has at least one cooling element, preferably two cooling elements for each of the battery cells via which the at least one first cell pole connection of the respective battery cell is coupled to the module housing and/or the housing component.

19. The battery according to claim 11, wherein the housing component is designed as a cooling wall or cooling cover or cooling base and has at least one cooling channel which can be traversed by a coolant.

20. A motor vehicle having a battery according to claim 11.

21. The battery according to claim 12, wherein the battery has a cell connector electrically connected to the first cell pole connection, wherein the insulation element is arranged between the cell connector and the first connection region of the cooling element.

22. The battery according to claim 13, wherein the insulation element is designed as an adhesive layer made of an adhesive.

23. The battery according to claim 12, wherein the cooling element comprises a curved and/or angled rail or is designed as such.

24. The battery according to claim 13, wherein the cooling element comprises a curved and/or angled rail or is designed as such.

25. The battery according to claim 14, wherein the cooling element comprises a curved and/or angled rail or is designed as such.

26. The battery according to claim 12, wherein the cooling element in the second connection region is arranged in direct contact with the module housing and/or the housing component, in particular welded, screwed or glued thereto.

27. The battery according to claim 13, wherein the cooling element in the second connection region is arranged in direct contact with the module housing and/or the housing component, in particular welded, screwed or glued thereto.

28. The battery according to claim 14, wherein the cooling element in the second connection region is arranged in direct contact with the module housing and/or the housing component, in particular welded, screwed or glued thereto.

29. The battery according to claim 15, wherein the cooling element in the second connection region is arranged in direct contact with the module housing and/or the housing component, in particular welded, screwed or glued thereto.

30. The battery according to claim 11, wherein the battery has a connecting portion which extends in the first direction, is arranged with one end on the housing component, is arranged in a second direction next to the cell stack and connects the cooling element to the housing component.
